(19) United States
(12) Patent Application Publication
(10) Pub. No.: US 2007/0046660 A1
(43) Pub. Date: Mar. 1, 2007

(54) Power supply circuit and electronic appliance therewith

(75) Inventor: Tsutomu Satoh, Katsuragi-Shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/503,916

(22) Filed: Aug. 15, 2006

(30) Foreign Application Priority Data
Aug. 24, 2005 (JP) 2005-243055

(51) Int. Cl. G09G 5/00

(52) U.S. Cl. 345/211

(57) ABSTRACT

A power supply circuit (10) has a current control portion (5) that controls, at a predetermined level, the currents passed through LEDs (3) and (4); a current setting portion (6) that sets, in the current control portion (5), the level of currents to be passed through the LEDs (3) and (4); and a checking portion (7) that checks whether or not currents at the current level set by the current setting portion (6) can be passed through the LEDs (3) and (4). The checking portion (7), on recognizing a condition in which at least one of the LEDs (3) and (4) cannot be fed with a current at the level set by the current setting portion (6), feeds the current setting portion (6) with a signal indicating the condition; on receiving the signal, the current setting portion (6) changes the currently set current level to a current level at which currents can be passed through both the LEDs (3) and (4). This helps realize an LED driving power supply circuit that, despite having a small circuit scale, tolerates a wide range for the supplied voltage.

This nonprovisional application claims priority under 35 U.S.C. § 119(a) on Patent Application No. 2005-243055 filed in Japan on Aug. 24, 2005, the entire contents of which are hereby incorporated by reference.

### BACKGROUND OF THE INVENTION

1. Field of the Invention

The present invention relates to a power supply circuit, and more particularly to a driving power supply circuit that is provided for the purpose of stably driving an LED.

2. Description of Related Art

Today, cellular phones incorporating color liquid crystal displays are widespread. Typically used as the backlights for such liquid crystal displays are white LEDs, and there have conventionally been known power supply circuits for driving such LEDs (for example, see JP-A-2004-166342).

FIG. 8 is a diagram showing the configuration of part of a liquid crystal display provided with the just-mentioned power supply circuit based on conventional technology. The liquid crystal display 900 is composed of a power supply portion 901 that supplies a direct-current voltage; a step-up circuit 902 that steps up the voltage outputted from the power supply portion 901; LEDs 903 and 904 that, when currents are passed therethrough, emit light of predetermined colors at light intensities commensurate with the amounts of current passed therethrough; a current control portion 905 that controls the current levels of the currents passing between the anode and the cathode of the individual LEDs 903 and 904; and a current setting portion 906 that sets the current level of currents to be passed through the LEDs 903 and 904 and gives the current control portion 905 instructions corresponding thereto.

It should be understood that, although two LEDs are shown in FIG. 8, the number of LEDs actually used is not limited to two but may be three or more while the overall configuration is kept substantially the same.

In FIG. 8, the amounts of current passed between the anode and the cathode of the individual LEDs 903 and 904 are controlled by the current control portion 905 so as to be equal to the current level previously set by the current setting portion 906. The current control portion 905 is composed of, for example, a constant current source that allows the level of the current it produces to be varied; and transistors that allow the levels of the currents passing therethrough to be specified according to the level of the current outputted from the constant current source. In this case, a first transistor is connected to the cathode of the LED 903, and a second transistor is connected to the cathode of the LED 904.

FIG. 9 is a diagram showing an example of the detailed configuration of the current control portion 905. A direct-current voltage V_{cc} is applied via a resistor R911 to the drain electrode of a MOS transistor Q911. The drain electrode and the gate electrode of the MOS transistor Q911 are connected together, and the source electrode of the MOS transistor Q911 is grounded.

The drain electrode of a MOS transistor Q912 is connected to the cathode of the LED 903; the gate electrode of the MOS transistor Q912 is connected to the gate electrode of the MOS transistor Q911; and the source electrode of the MOS transistor Q912 is grounded.

Likewise, the drain electrode of a MOS transistor Q913 is connected to the cathode of the LED 904; the gate electrode of the MOS transistor Q913 is connected to the gate electrodes of the MOS transistors Q911 and Q912; and the source electrode of the MOS transistor Q913 is grounded.

In this configuration, as the resistance of the resistor R911 is varied, the drain current I_{d911} of the MOS transistor Q911 can be controlled. On the other hand, since the MOS transistors Q911 and Q912 form a current mirror circuit, and the MOS transistors Q911 and Q913 form a current mirror circuit, so long as the direct-current voltage V_{cc} is sufficiently high, the drain currents I_{d912} and I_{d913} are equal to the drain current I_{d911}.

As shown in FIG. 8, the power supply circuit includes the step-up circuit 902, which allows a sufficiently high voltage to be applied to the anodes of the LEDs 903 and 904. This, despite the voltage drops across the LEDs 903 and 904, keeps the drain-source voltages of the MOS transistors Q912 and Q913 so high as to pass therethrough drain currents equal to I_{d911}.

Requiring a step-up circuit as described above, the power supply circuit disclosed in JP-A-2004-166342 mentioned above, disadvantageously, requires an unduly large chip size for the power supply circuit as a whole, and also produces large switching noise attributable to a component, such as a coil, used to build the step-up circuit.

On the other hand, if the step-up circuit 902 is omitted from the power supply circuit shown in FIG. 8, as the output voltage of the power supply portion 901 decreases, inconveniently, a difference arises between the levels of the currents passing through the LEDs 903 and 904. How this happens will be described below.

FIG. 10 is a graph showing the relationship between the drain-source voltage V_{DS} and the drain current I_{D} of the MOS transistors Q912 and Q913. Here, the MOS transistors Q912 and Q913 are assumed to have substantially the same characteristics.

In a MOS transistor, under the condition that the gate-source voltage V_{GS} is constant, the drain current remains constant so long as the drain-source voltage V_{DS} is higher than a threshold voltage. For example, under the condition that V_{GS}=V_{gs1}, when the drain-source voltage V_{DS} is higher than V_{ds1}, the drain current I_{D} remains equal to I_{d1} and, when the drain-source voltage V_{DS} is lower than V_{ds1}, the drain current I_{D} no longer remains equal to I_{d1} but decreases as the drain-source voltage V_{DS} decreases.

Generally speaking, in LED devices, even when the currents passing therethrough are equal, the forward voltage V_{F} between the anode and the cathode thereof varies from one individual device to another. For example, when the level of currents to be passed through the LEDs 903 and 904 is set at 20 mA, it may occur that the forward voltage V_{F} across the LED 903 is 3.3 V while the forward voltage V_{F} across the LED 904 is 3.5 V. Even in this case, the levels of the currents passing through the two LED devices are equal; since LEDs emit light at intensities commensurate with the levels of the currents passed therethrough, the LEDs 903 and 904 emit light with equal brightness.

When the step-up circuit 902 is omitted, the drain-source voltage V_{DS} of the MOS transistors Q912 and Q913 is equal to the difference between the supplied voltage and the forward voltage V_{F} of the LEDs. In a case where the power supply portion 901 is built with, for example, a lithium ion battery, the output voltage of the power supply portion 901 gradually decreases as use progresses starting in a fully charged state.

In this configuration, consider a case where the level of currents to be passed through both the LEDs 903 and 904 is set at I_{d2} (see FIG. 10). Then, the resistance of the resistor R911 is so set that the gate-source voltage V_{GS} of the MOS transistors Q912 and Q913 is equal to V_{gs2}. As use progresses starting with a fully charged state, the resistance of the resistor R911 is so varied as to control the gate-source voltage V_{GS} to remain equal to V_{gs2}.

Here, if the forward voltage V_{F904} of the LED 904 is higher than the forward voltage V_{F903} of the LED 903, as the supplied voltage decreases, the drain-source voltage V_{DS} of the MOS transistors Q912 and Q913 decreases. When the supplied voltage becomes lower than a predetermined level, the drain-source voltage V_{ds913} of the MOS transistor Q913, which is connected to the LED 904 with the higher forward voltage, becomes lower than a threshold voltage V_{ds2}, while the drain-source voltage V_{ds912} of the MOS transistor Q912 is still higher than the threshold voltage V_{ds2} owing to the forward voltage V_{F903} of the LED 903 being lower than V_{F904}.

As the supplied voltage further decreases, while the MOS transistor Q912 remains in a saturated region A92 where it can keep the drain current thereof constant, the MOS transistor Q913, with the drain-source voltage V_{ds} thereof lower than the threshold voltage V_{ds2}, is already in a non-saturated region A91 in which it cannot keep the drain current thereof constant. That is, while the LED 903 connected to the drain electrode of the MOS transistor Q912 emits light with brightness commensurate with the current level I_{d2}, the LED 904 connected to the drain electrode of the MOS transistor Q913 is fed with a current whose level is lower than I_{d2}, and thus emits light with less brightness than the LED 903.

That is, the LEDs 903 and 904 emit light with different brightness, resulting in uneven brightness over the liquid crystal screen, for example with higher brightness in a right-hand part thereof than in a left-hand part thereof.

Conventionally, this inconvenience is overcome by controlling the LEDs in such a way that they are turned off before the level of the current passing through the LED 904 becomes lower than I_{d2}. This, however, disadvantageously narrows the tolerated range for the supplied voltage.

### SUMMARY OF THE INVENTION

In view of the conventionally experienced disadvantages and inconveniences discussed above, it is an object of the present invention to provide an LED driving power supply circuit that, despite including no step-up circuit, tolerates a wide range for the supplied voltage. It is another object of the present invention to provide an electronic appliance provided with such a power supply circuit.

To achieve the above objects, according to the present invention, a power supply circuit is provided with a first current control portion that controls, at a predetermined current level, the currents fed from a power supply portion to a plurality of LEDs connected in parallel with one another; a first current setting portion that sets, in the first current control portion, a level of currents to be passed through the LEDs; and a checking portion that checks whether currents at the current level set by the first current setting portion can be passed through the LEDs. Here, when the checking portion recognizes a condition in which at least one of the LEDs cannot be fed with a current at the level set by the first current setting portion, the checking portion feeds the first current setting portion a signal indicating the condition; on receiving the signal, the first current setting portion changes the currently set current level to a current level at which currents can be passed through all the LEDs.

With the configuration according to the present invention, when it is recognized that at least one of the LEDs cannot be fed with a current at the specified level, the set current level is automatically changed so that currents at equal levels are passed through all the LEDs. This helps eliminate brightness unevenness among the LEDs. That is, even when the supplied voltage lowers, without the need for a step-up circuit, all the LEDs can be made to emit light with equal brightness.

### BRIEF DESCRIPTION OF THE DRAWINGS

FIG. 1 is a diagram showing an example of the configuration of part of a liquid crystal display provided with a power supply circuit according to the present invention;

FIG. 2 is a diagram showing an example of the detailed configuration of the current control portion 5 shown in FIG. 1;

FIG. 3 is a graph showing the relationship between the drain-source voltage V_{DS} and the drain current I_{D} of the MOS transistors shown in FIG. 2;

FIG. 4 is a graph showing the relationship between the LED anode electrode application voltages and the current control performance of the LEDs 3 and 4;

FIG. 5 is a graph showing the relationship between the set current level, as set on an analog basis, and the anode electrode application voltages;

FIG. 6 is a diagram showing an example of the configuration of the current control portion 5 that performs control such as to pass currents in fixed proportions;

FIG. 7 is a diagram showing another example of the configuration of part of a liquid crystal display provided with a power supply circuit according to the present invention;

FIG. 8 is a diagram showing the configuration of part of a liquid crystal display provided with a power supply circuit based on conventional technology;

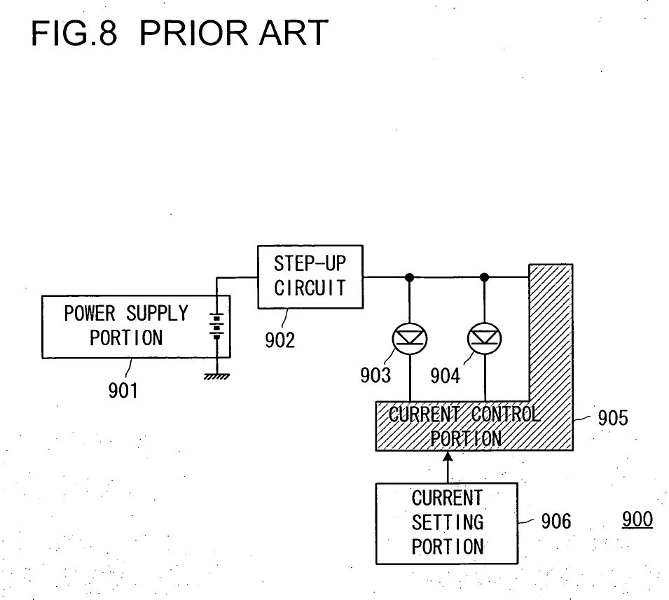

FIG. 9 is a diagram showing an example of the detailed configuration of the current control portion 905 shown in FIG. 8; and

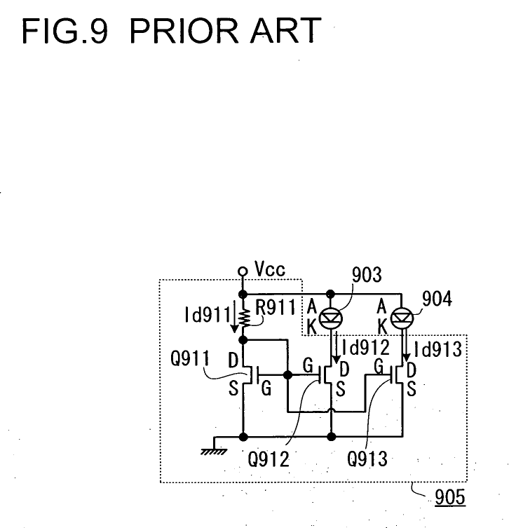

FIG. 10 is a graph showing the relationship between the drain-source voltage V_{DS} and the drain current I_{D} of the MOS transistors shown in FIG. 9.

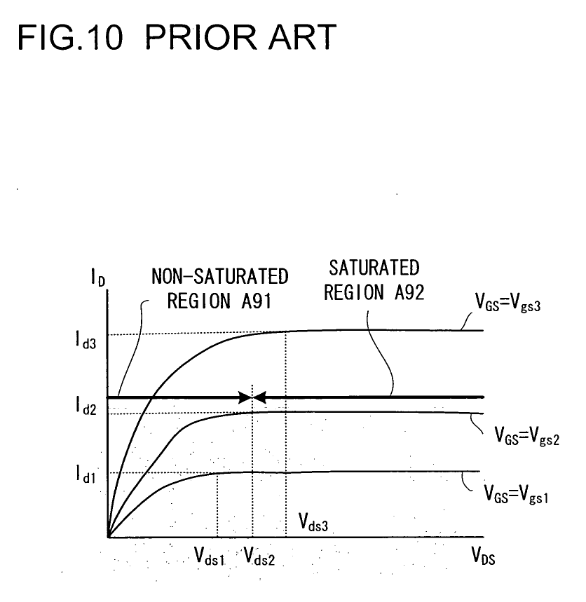

### DETAILED DESCRIPTION OF PREFERRED EMBODIMENTS

First Embodiment

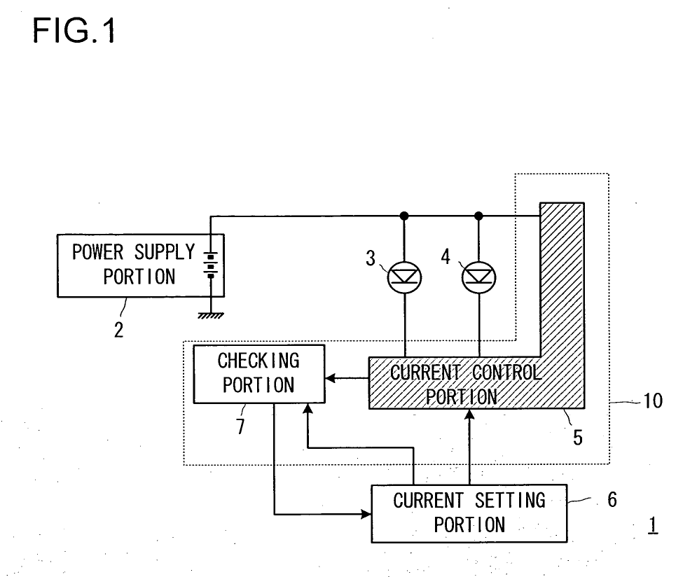

A first embodiment of the present invention will be described below with reference to the drawings. FIG. 1 is a diagram showing the configuration of part of a liquid crystal display provided with a power supply circuit according to the present invention.

The liquid crystal display 1 shown in FIG. 1 is composed of a power supply portion 2 that supplies a direct-current voltage; LEDs 3 and 4 that, when current is passed therethrough, emit light of predetermined colors at light intensities commensurate with the amounts of current passed therethrough; a current control portion 5 that controls the current levels of the currents passing between the anode and the cathode of the individual LEDs 3 and 4; a current setting portion 6 that sets the current level of currents to be passed through the LEDs 3 and 4 and gives the current control portion 5 instructions corresponding thereto; and a checking portion 7 that checks whether or not currents at the current level set by the current setting portion 6 can be passed through the LEDs 3 and 4 and feeds the result of the checking to the current setting portion 6.

The current control portion 5 and the checking portion 7 together constitute a power supply circuit 10. How these operate will be described later.

It should be understood that, although two LEDs are shown in FIG. 1, the number of LEDs actually used is not limited to two but may be three or more so long as the LEDs are connected in parallel with one another.

In FIG. 1, the amounts of current passed between the anode and the cathode of the individual LEDs 3 and 4 are controlled by the current control portion 5 so as to be equal to the current level previously set by the current setting portion 6.

The current control portion 5 is composed of, for example, a constant current source that allows the level of the current it produces to be varied; and transistors that allow the levels of the currents passing therethrough to be specified according to the level of the current outputted from the constant current source. Here, the first transistor is connected to the cathode of the LED 3, and the second transistor is connected to the cathode of the LED 4. It should be understood that any configuration other than specifically described here may be adopted so long as specified amounts of current can be passed through the individual LEDs.

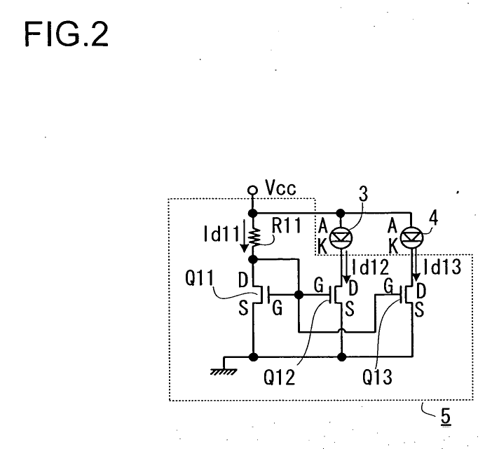

FIG. 2 is a diagram showing an example of the detailed configuration of the current control portion 5. A direct-current voltage V_{cc} is applied via a resistor R11 to the drain electrode of a MOS transistor Q11. The drain electrode and the gate electrode of the MOS transistor Q11 are connected together, and the source electrode of the MOS transistor Q11 is grounded.

The drain electrode of a MOS transistor Q12 is connected to the cathode of the LED 3; the gate electrode of the MOS transistor Q12 is connected to the gate electrode of the MOS transistor Q11; and the source electrode of the MOS transistor Q12 is grounded.

Likewise, the drain electrode of a MOS transistor Q13 is connected to the cathode of the LED 4; the gate electrode of the MOS transistor Q13 is connected to the gate electrodes of the MOS transistors Q11 and Q12; and the source electrode of the MOS transistor Q13 is grounded.

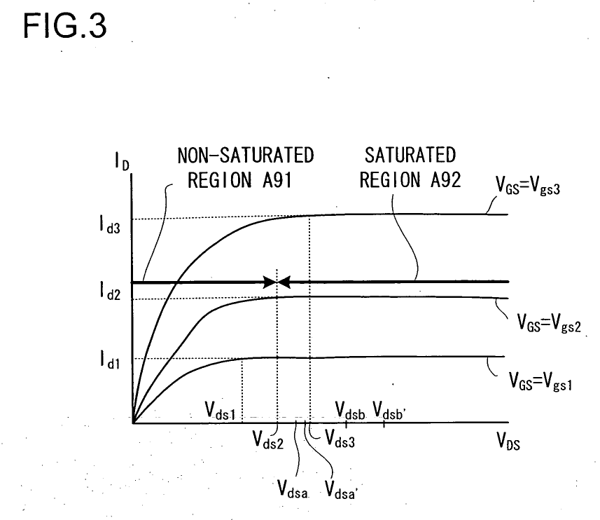

The MOS transistors Q12 and Q13 are assumed to have substantially the same characteristics. FIG. 3 is a graph showing the relationship between the drain-source voltage V_{DS} and the drain current I_{D} of the MOS transistors Q12 and Q13.

In a MOS transistor, under the condition that the gate-source voltage V_{GS} is constant, the drain current remains constant so long as the drain-source voltage V_{DS} is higher than a threshold voltage. For example, under the condition that V_{GS}=V_{gs1}, when the drain-source voltage V_{DS} is higher than V_{ds1}, the drain current I_{D} remains equal to I_{d1} and, when the drain-source voltage V_{DS} is lower than V_{ds1}, the drain current I_{D} no longer remains equal to I_{d1} but decreases as the drain-source voltage V_{DS} decreases.

Thus, under the condition that V_{GS}=V_{gs1}, when the current setting portion 6 instructs the current control portion 5 to pass a current I_{d1}, if the drain-source voltage V_{DS} of one of the LEDs 3 and 4 is lower than V_{ds1}, the LED whose V_{DS} is lower than V_{ds1} cannot be fed with a current I_{d1}.

The checking portion 7 includes a voltage measurement portion that measures the gate-source voltage V_{GS} and the drain-source voltage V_{DS} of the MOS transistors and the direct-current voltage applied to the LEDs; and a memory in which are stored the characteristic (V_{DS}-I_{D} characteristic) of the MOS transistors and the forward voltage characteristic of the LEDs. With these, the checking portion 7 checks whether currents at the current level specified by the current setting portion 6 can be passed through the LEDs. The result of this checking is fed to the current setting portion 6. The checking portion 7 may be fed with the level of the direct-current voltage V_{cc} at predetermined time intervals.

If the checking portion 7 finds that the current level previously specified by the current setting portion 6 is such that currents at that current level can be passed, the checking portion 7 feeds that current level to the current setting portion 6; in contrast, if the checking portion 7 finds that the previously specified current level is such that at least one of the LEDs cannot be fed with a current at the specified current level, the checking portion 7 calculates, based on the characteristics of the MOS transistors stored in the memory, the current level at which currents can be passed through both the LEDs, and feeds that current level to the current setting portion 6. How the calculation is performed here will be described later.

With this configuration, even when a difference in forward voltage between the LEDs 3 and 4 causes a difference in drain-source voltage V_{DS} between the transistors Q12 and Q13, and as a result the transistors Q12 or Q13 can no longer be kept in a saturated region as the direct-current voltage V_{cc} lowers, the set current level is automatically changed to a current level at which equal currents can be passed through both the LEDs. In this way, uneven brightness among the LEDs is avoided.

Now, how the current level is set anew by the checking portion 7 will be described with the transistor characteristic diagram of FIG. 3.

Here, it is assumed that, currents to be passed through the LEDs 3 and 4 have previously been set at a current level of I_{d3} by the current setting portion 6. The current setting portion 6 may be so configured as to be able to be operated by the user to allow the display brightness of the liquid crystal display 1 to be adjusted according to the user's operation.

It is also assumed that, even equal currents are passed through the LEDs 3 and 4, there is a difference in anode-cathode forward voltage V_{F} between the LEDs 3 and 4. For example, it is assumed that, in a case where a current I_{d3} is passed through the LEDs 3 and 4, the forward voltage V_{F3} of the LED 3 equals V_{f33}, that the forward voltage V_{F4} of the LED 4 equals V_{f43}, and that V_{f33}<V_{f43}.

The current setting portion 6 notifies the checking portion 7 that currents to be passed through the LEDs are set at a current level of I_{d3}. Based on V_{GS} and V_{DS} of the transistors Q12 and Q13 and the characteristics thereof, the checking portion 7 checks whether or not currents at a current level of I_{d3} can be passed through the LEDs.

Specifically, notified that currents to be passed through the LEDs are set at a current level of I_{d3}, the checking portion 7 refers to the characteristics of the transistors stored in the memory, and calculates the level of V_{GS} that makes the drain currents constant at I_{d3}. Simultaneously, by referring to the forward voltage characteristics of the LEDs stored in the memory, the checking portion 7 reads the forward voltage V_{F} at a current level of I_{d3}, and calculates V_{DS} of the transistors based on the direct-current voltage (or the direct-current voltage V_{cc}) applied to the anode electrode of the LEDs and V_{F} of the LEDs.

Here, if the calculated V_{DS} of both the transistors is higher than the threshold level, currents can be passed at the specified current level; thus, the checking portion 7 returns to the current setting portion 6 a signal indicating that currents can be passed at the specified current level, and, on receiving that signal, the current setting portion 6 instructs the current control portion 5 to pass currents at a current level of I_{d3} through the LEDs. The current control portion 5 sets the resistance of the resistor R11 to fulfill V_{GS}=V_{gs3} so that currents at a current level of I_{d3} are passed through the LEDs.

In contrast, if the calculated V_{DS} of at least one of the transistors is lower than the threshold level, a current at the specified current level cannot be passed through the LED connected to that transistor. In this case, the checking portion 7 returns to the current setting portion 6 a signal indicating that a current cannot be passed at the specified current level, and the current setting portion 6 sets anew the specified current level. The current setting portion 6 may be so configured as to adjust the current level according to setting means such as the duty factor of a PWM signal from an external CPU or the output signal from an illuminance sensor.

For example, in a case where V_{DS} of the MOS transistor Q12 fulfills V_{ds12}=V_{dsb} and V_{DS} of the MOS transistor Q13 fulfills V_{ds13}=V_{dsa}, for the MOS transistor Q12, making V_{GS}=V_{gs3} makes the drain current I_{d}=I_{d3}; however, for the MOS transistor Q13, which is already in a non-saturated region, making V_{GS}=V_{gs3} does not keep the drain current I_{d}=I_{d3}.

In this case, the checking portion 7 instructs the current setting portion 6 to change the set current level from I_{d3} to I_{d2}. The level I_{d2} here is calculated, by the checking portion 7 based on the forward voltage of the LEDs and the anode electrode application voltages of the LEDs, so as to allow equal currents to be passed.

For example, it is known that changing the set current level to I_{d2} makes, for the MOS transistor Q12, V_{ds12}=V_{dsb′} and, for the MOS transistor Q13, V_{ds13}=V_{dsa′}. In this case, by adjusting the resistor R11 to fulfill V_{GS}=V_{gs2}, currents at a current level of I_{d2} can be passed through both the LEDs. The current setting portion 6 instructs the current control portion 5 to change the set current level to I_{d2}, and the current control portion 5 changes the resistance of the resistor R11 so that currents at a current level of I_{d2} are passed through the LEDs.

By performing such checking at predetermined intervals, when at least one of the transistors reaches a non-saturated region, the set current level is automatically changed so that currents at equal levels are passed through the LEDs, eliminating uneven brightness between the LEDs. That is, even when the supplied voltage lowers, without the need for a step-up circuit, both the LEDs can be made to emit light with equal brightness.

In the above description, the power supply portion 2 is assumed to be built with a battery, such as a lithium-ion battery, whose output voltage lowers as use progresses. It should be understood, however, that the present invention may be applied to power supplies in general whose output voltage varies.

In the above description, the checking portion 7 measures the direct-current voltage applied to the LEDs and checks, based on the characteristics of the MOS transistors and the forward characteristics of the LEDs, whether or not currents at the specified current levels can be passed. Alternatively, based on the forward characteristics of the LEDs and the characteristics of the MOS transistors connected thereto, the relationship between the threshold current levels up to which (controllable current levels within which) currents can be passed through the LEDs and the LED anode electrode application voltages may be previously calculated and stored in a memory so that, based on this data, the current level is changed. In the following description, the controllable current levels within which currents can be passed through the LEDs will be referred to as the current control performance thereof.

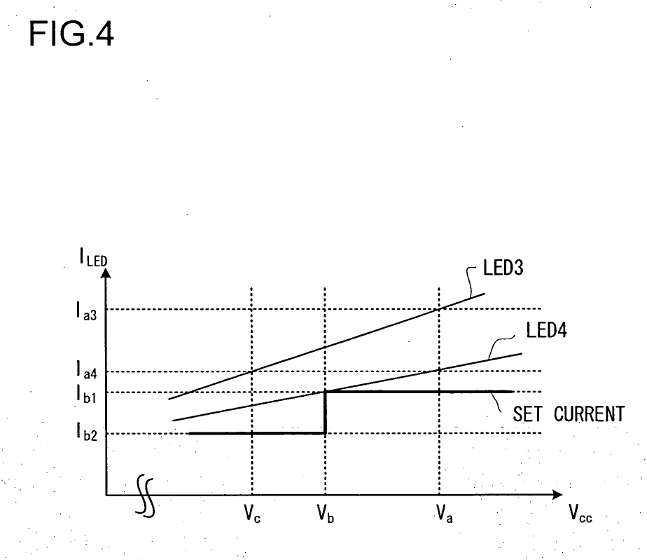

FIG. 4 is a graph showing the relationship between the LED anode electrode application voltages and the current control performance of the LEDs 3 and 4. This graph shows that, for example, in a case where a voltage Vₐ is applied to the anode electrodes, the LED 3 allows a current up to a current level of Iₐ₃ to be passed therethrough, and the LED 4 allows a current up to a current level of Iₐ₄ to be passed therethrough.

Under the characteristics shown in FIG. 4, in a case where the set current level is I_{b1}, when the anode electrode application voltages are in the range equal to or higher than V_{b}, a current I_{b1} can be passed through the LEDs 3 and 4, but, when the anode electrode application voltages are lower than V_{b}, a current I_{b1} cannot be passed through the LED 4.

In this case, while the liquid crystal display 1 is driven at the set current level I_{b1}, when the checking portion 7 recognizes the anode electrode application voltage of the LED 4 to be lower than V_{b}, the checking portion 7 instructs the current setting portion 6 to change the set current level to I_{b2}, which is lower than I_{b1}.

When the set current level is I_{b2}, even if the anode electrode application voltages are equal to or lower than V_{b}, if they are in the range equal to or higher than a predetermined voltage, a current at the current level of I_{b2} can be passed through the LED 4, and thus currents at equal current levels can be passed through both the LEDs 3 and 4. In this way, uneven brightness between the LEDs is avoided.

The current level thus set anew may be one of previously determined levels at predetermined intervals. In this case, when the anode electrode application voltages become lower than the maximum level sufficiently high to maintain the current level set anew, the checking portion 7 may instruct the current setting portion 6 to change the set current level to the next current level, or, before the anode electrode application voltages become lower than the maximum level sufficiently high to maintain the current level set anew, the checking portion 7 may give such an instruction to change the set current level.

In the above description, an instruction to change the set current level is given when the LED anode electrode application voltages become lower than a predetermined level. Alternatively, it is also possible to give an instruction to change the set current level when the output voltage of the power supply portion 2 become lower than a predetermined level. In this case, if the rate at which the voltage of the power supply portion 2 lowers (the relationship between the use duration and the output voltage) is previously known, the checking portion 7 may instruct the current setting portion 6 to change the set current level when a predetermined period has elapsed after start-up.

Resistors for detecting the currents passing through the LEDs may be additionally connected so that the checking portion 7, by measuring the levels of the currents passing through those resistors, instructs the current setting portion 6 to set the set current level anew when the measured current levels become lower than the current level set by the current setting portion 6.

The current level set anew may be set on a digital basis at a current level commensurate with the currently set current level (for example, at a current level one-fourth of the set current level). This allows highly accurate setting beforehand, and thereby helps enhance the flexibility in design. Moreover, the overall brightness of the liquid crystal display 1 is reduced, allowing the user to visually recognize that the voltage of the power supply portion 2 has lowered.

In a case where characteristics as shown in FIG. 4 are previously known, the current level may be set anew on an analog basis as a result of the current setting portion 6 being instructed with a new current level according to the characteristics of the one among the LEDs that exhibits the lowest current control performance under the condition that equal voltages are applied to the anode electrodes thereof.

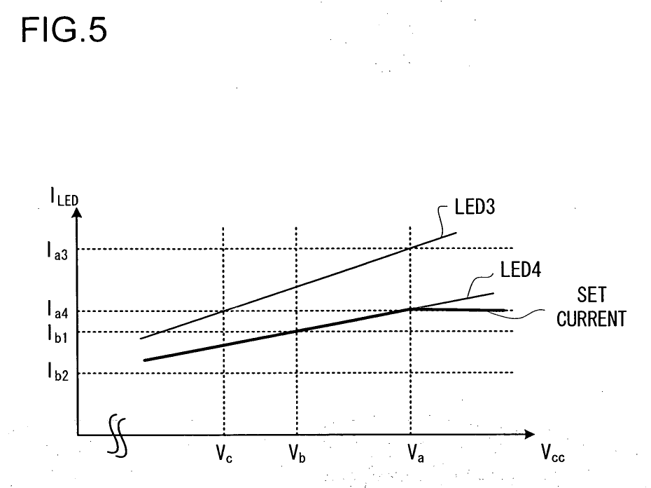

FIG. 5 is a graph showing the relationship between the set current level, as set on an analog basis as described above, and the anode electrode application voltages. By changing the set current level to a current level barely within the current control performance of the LED 4 according to the anode electrode application voltages, currents at equal levels can be passed through both the LEDs 3 and 4. For exanple, as shown in FIG. 5, in a case where the initially set current level is Iₐ₄, when the anode electrode application voltages are in the range equal to or higher than Vₐ, the set current level is kept at Iₐ₄, and, when the anode electrode application voltages become lower than Vₐ, the current setting portion 6 instructs the current control portion 5 to change the set current level to a current level barely within the current control performance of the LED 4.

Through the control described above, even when the output voltage of the power supply portion 2 lowers, the brightness of the LEDs is prevented from dropping abruptly, and can instead be made to lower gradually. This prevents abrupt lowering of the brightness of the liquid crystal display 1. This control is effective in white LEDs used as a backlight for a liquid crystal display in portable appliances, because the LED currents there should ideally be kept constant.

In the above description, the current setting portion 6 is provided outside the power supply circuit 10; instead, it may be provided within the power supply circuit 10. This eliminates the need to program an external signal, also eliminates the need to provide a port for signal output, and thus helps simplify the design of peripheral circuits.

In the above description, control is performed such that currents at equal levels are passed through the LEDs 3 and 4; instead, control may be performed such that currents in fixed proportions are passed.

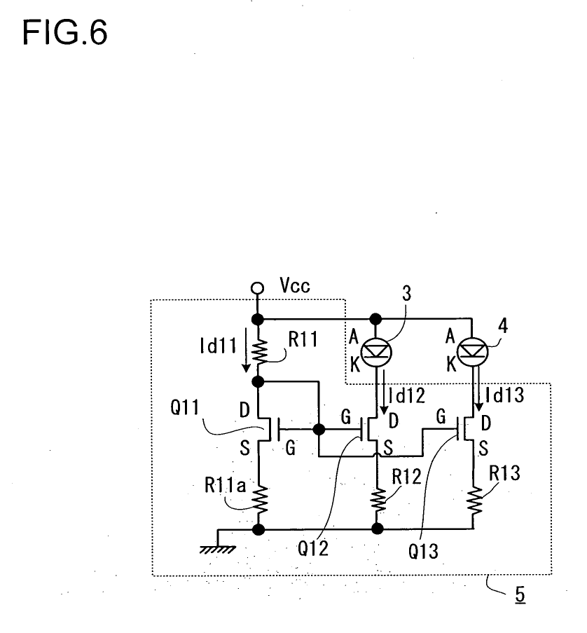

FIG. 6 is a diagram showing an example of the configuration of the current control portion 5 that performs control such as to pass currents in fixed proportions. To the source electrode of the MOS transistor Q11, a resistor R11a is connected. By varying the resistances of variable resistors R12 and R13 connected to the source electrodes of the transistors Q12 and Q13, it is possible to vary the current levels at which currents are passed through the LEDs 3 and 4.

Specifically, the variable resistors R12 and R13 are given resistances in predetermined proportions relative to the resistance of the resistor R11a, so that the current levels through the LEDs 3 and 4 are so controlled as to be kept in the predetermined proportions.

By keeping a fixed current ratio between the LEDs in this way, it is possible to apply the present invention in cases where, as with RGB three-color LEDs, the current ratio needs to be kept fixed to maintain the desired hue. Three-color LEDs are used as auxiliary light sources, called picture lights, in camera-equipped cellular phones, illumination light sources, backlights for liquid crystal television monitors, and the like, and the present invention then finds applications in these.

In the above description, the current proportions are varied by adjusting the resistances of R12 and R13; instead, the power supply circuit may be given any other configuration so long as currents in fixed proportions are passed through the LEDs.

The current control portion 5 may be given any configuration other than specifically shown in FIG. 2 so long as it can pass currents at specified current levels through the LEDs.

In the above description, the means for storing characteristics is realized with a memory; instead, it is possible to use any other type of storing means (for example, it may be realized on an analog basis with an electronic circuits).

In the above description, the checking portion 7 stores the characteristics of the transistors and the LEDs and calculates, based on those characteristics, reference current or voltage threshold levels; instead, the checking portion 7 may be provided with a reference output portion that previously calculates reference current or voltage threshold levels based on the characteristics of the transistors and the LEDs and outputs those reference levels. This reference output portion may be built as an analog electronic circuit, or may be realized on a digital basis.

Here, the checking portion 7 may be so configured as to perform checks similar to those described above by comparing the current threshold levels outputted from the reference output portion with the current level set by the current setting portion 6. Likewise, in a case where voltage levels are compared, the checking portion 7 may be so configured as to perform checks similar to those described above by comparing the voltage threshold levels outputted from the reference output portion with the drain-source voltages of the transistors or the output voltage of the power supply portion 2.

Second Embodiment

A second embodiment of the present invention will be described below with reference to the drawings. Such parts as are found also in the first embodiment are identified with common reference numerals, and no detailed description thereof will be repeated.

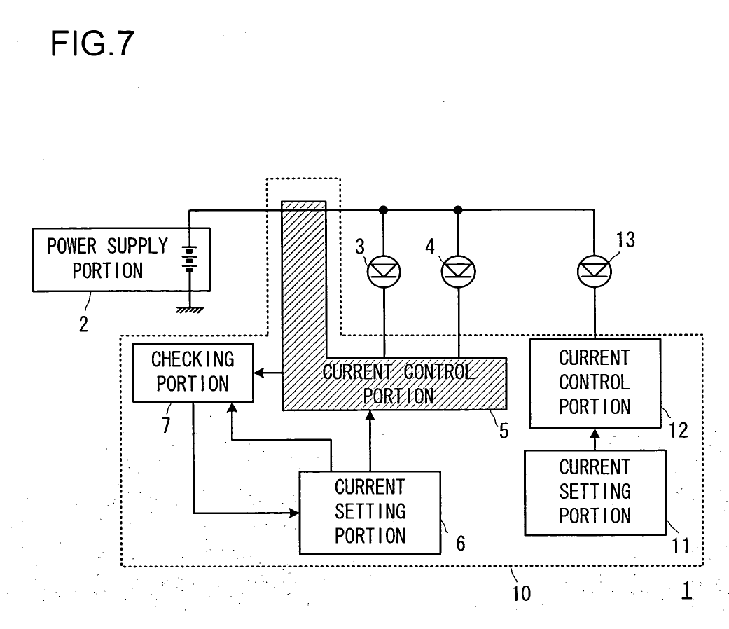

FIG. 7 is a diagram showing the configuration of part of a liquid crystal display provided with a power supply circuit of this embodiment. In this embodiment, as compared with the first embodiment, there are additionally provided a current setting portion 11 separate from the current setting portion 6; a current control portion 12 that performs control such that a current at the current level set by the current setting portion 11 is passed; and an LED 13 through which a current at the current level controlled by the current control portion 12 is passed. Although the current setting portions 6 and 11 are shown to be provided within the power supply circuit 10 in FIG. 7, they may instead be provided outside the power supply circuit 10.

Unlike the current control portion 5, the current control portion 12 performs control such that, irrespective of the result of the checking by the checking portion 7, a current at the level set by the current setting portion 11 is passed through the LED 13.

As described above in connection with the first embodiment, if currents at the current level previously set by the current setting portion 6 can be passed through both the LEDs 3 and 4, the checking portion 7 feeds that current level to the current setting portion 6; if at least one of the LEDs cannot be fed with a current at that current level, the checking portion 7 calculates, based on the characteristics of the MOS transistors stored in the memory, a current level at which currents can be passed through both the LEDs, and feeds this current level to the current setting portion 6. Then, currents at the thus calculated current level are fed to the LEDs 3 and 4.

On the other hand, through the LED 13, a current at the level specified by the current setting portion 11 is kept being passed. That is, with this configuration, the LED 13 can be subjected to control different from that to which the LEDs 3 and 4 are subjected, and this allows the LED 13 to be used where brightness itself matters more than evenness of brightness, contributing to enhanced flexibility in control. For example, while the LEDs 3 and 4 are used as LEDs serving as a backlight for a liquid crystal display, where evenness of brightness matters, the LED 13 is used as an LED for a sub liquid crystal display or for a flash light, where brightness itself matters more than evenness of brightness.

The power supply circuit of this embodiment may be implemented in combination with the configuration of the first embodiment described previously. For example, the current control portion 5 may control the current levels through the LEDs 3 and 4 in fixed proportions.

The present invention aims at providing an LED driving power supply circuit that, despite including no step-up circuit, tolerates a wide range for the supplied voltage. However, it may be applied even to a power supply circuit provided with a step-up circuit to obtain enhanced power efficiency.

By providing a step-down circuit instead of a step-up circuit, when the supplied voltage is high, the electric power, of which the excess part has conventionally been all dissipated by the current control portion 5, can be stepped down highly efficiently with a step-down switching regulator or step-down charge pump, enhancing the efficiency of the power supply circuit. Providing a step-up/step-down circuit helps further widen the tolerated range for the supplied voltage, and helps obtain enhanced power efficiency.

Power supply circuits according to the present invention can be suitably used as LED driving power supply circuits provided in electronic appliances, such as cellular phones, digital cameras, portable game machines, portable audio players, and PDAs (personal digital assistants), that incorporate a color liquid crystal screen employing white LEDs as a backlight source and that operate from a battery such as a lithium-ion battery.

What is claimed is:

1. A power supply circuit comprising:
a first current control portion that controls, at a predetermined current level, currents fed from a power supply portion to a plurality of LEDs connected in parallel with one another;
a first current setting portion that sets, in the first current control portion, a level of currents to be passed through the LEDs; and
a checking portion that checks whether currents at the current level set by the first current setting portion can be passed through the LEDs;
wherein
when the checking portion recognizes a condition in which at least one of the LEDs cannot be fed with a current at the level set by the first current setting portion, the checking portion feeds the first current setting portion a signal indicating the condition, and
on receiving the signal, the first current setting portion changes the currently set current level to a current level at which currents can be passed through all the LEDs.

2. The power supply circuit of claim 1, further comprising:
a second current control portion that controls, at a predetermined current level, a current fed to at least one sub-LED connected in parallel with the LEDs, the current passing through the sub-LED not being controlled by the first current control portion; and
a second current setting portion that sets, in the second current control portion, a level of a current to be passed through the sub-LED;
wherein,
irrespective of a result of checking by the checking portion, the second current control portion controls, at the current level set by the second current setting portion, the current passing through the sub-LED.

3. The power supply circuit of claim 1, wherein
the checking portion compares the current levels of the currents passing through the LEDs with the current level set by the first current setting portion and, when the current level of the current flowing through at least one of the LEDs becomes lower than the current level set by the first current setting portion, the checking portion recognizes the condition in which at least one of the LEDs cannot be fed with a current at the level set by the first current setting portion.

4. The power supply circuit of claim 1, wherein
a controllable range of the level of the currents controlled by the first current control portion to be passed through the LEDs is determined according to an output voltage level of the power supply portion, and
the checking portion monitors the output voltage level of the power supply portion and checks whether or not the current level set by the first current setting portion is within the controllable range of the first current control portion, thereby checking whether or not currents at the current level set by the first current setting portion can be passed through the LEDs.

5. The power supply circuit of claim 1, wherein
a controllable range of the level of the currents controlled by the first current control portion to be passed through the LEDs is determined according to an output voltage level of the power supply portion,
the output voltage level is determined according to an operating duration of the power supply portion, and
the checking portion monitors the operating duration of the power supply portion and checks whether or not the current level set by the first current setting portion is within the controllable range of the first current control portion, thereby checking whether or not currents at the current level set by the first current setting portion can be passed through the LEDs.

6. The power supply circuit of claim 1, wherein
the first current control portion is configured as a current mirror circuit that includes, one for each column, transistors of which first electrodes are connected to one ends of the LEDs connected in parallel with one another, and
the checking portion has stored therein a relationship of voltages between first and second electrodes of the individual transistors with maximum controllable current levels for the LEDs connected to the transistors, and
the checking portion measures the voltages between the first and second electrodes of the transistors and also compares, column by column, the set current level with the maximum controllable current levels corresponding to the measured voltages, thereby checking whether or not currents at the current level set by the first current setting portion can be passed through the LEDs.

7. The power supply circuit of claim 6, wherein
the checking portion has stored therein a relationship of voltages between first and second electrodes of the individual transistors with maximum controllable current levels for the LEDs connected to the transistors, and
the checking portion measures the voltages between the first and second electrodes of the transistors and, when the set current level becomes higher than the maximum controllable current levels corresponding to the measured voltages, the checking portion instructs the first current setting portion to change the set current level.

8. The power supply circuit of claim 6, wherein
the checking portion has stored therein a relationship of voltages between first and second electrodes of the individual transistors with maximum controllable current levels for the LEDs connected to the transistors, and
the checking portion measures the voltages between the first and second electrodes of the transistors and, when the set current level becomes higher than near-maximum current levels calculated by subtracting predetermined values from the maximum controllable current levels corresponding to the measured voltages, the checking portion instructs the first current setting portion to change the set current level.

9. The power supply circuit of claim 6, wherein
when the checking portion recognizes the condition in which at least one of the LEDs cannot be fed with a current at the level set by the first current setting portion, the checking portion instructs the first current setting portion to change the set current level to the maximum controllable current level for the LED that is recognized as being unable to be fed with a current at the level set.

10. The power supply circuit of claim 1, wherein
the first current control portion is configured as a current mirror circuit that includes, one for each column, transistors of which first electrodes are connected to one ends of the LEDs connected in parallel with one another, and
the checking portion has stored therein a relationship of an output voltage level of the power supply portion with maximum controllable current levels for the LEDs connected to the transistors, and
the checking portion measures the output voltage level of the power supply portion and also compares, column by column, the set current level with the maximum controllable current levels corresponding to the measured voltage, thereby checking whether or not currents at the current level set by the first current setting portion can be passed through the LEDs.

11. The power supply circuit of claim 10, wherein
the checking portion has stored therein a relationship of an output voltage level of the power supply portion with maximum controllable current levels for the LEDs connected to the transistors, and
the checking portion measures the output voltage level of the power supply portion and, when the set current level becomes higher than the maximum controllable current levels corresponding to the measured voltage, the checking portion instructs the first current setting portion to change the set current level.

12. The power supply circuit of claim 10, wherein
the checking portion has stored therein a relationship of an output voltage level of the power supply portion with maximum controllable current levels for the LEDs connected to the transistors, and
the checking portion measures the output voltage level of the power supply portion and, when the set current level becomes higher than near-maximum current levels calculated by subtracting predetermined values from the maximum controllable current levels corresponding to the measured voltage, the checking portion instructs the first current setting portion to change the set current level.

13. The power supply circuit of claim 10, wherein
when the checking portion recognizes the condition in which at least one of the LEDs cannot be fed with a current at the level set by the first current setting portion, the checking portion instructs the first current setting portion to change the set current level to the maximum controllable current level for the LED that is recognized as being unable to be fed with a current at the level set.

14. The power supply circuit of claim 1, wherein
when the checking portion recognizes the condition in which at least one of the LEDs cannot be fed with a current at the level set by the first current setting portion, the checking portion instructs the first current setting portion to change the set current level to a new current level calculated by multiplying the currently set current level by a predetermined value.

15. The power supply circuit of claim 1, wherein
the LEDs are divided into a plurality of groups, and
the first current control portion performs control such that equal currents are passed through LEDs belonging to a same group and that a predetermined current ratio is maintained among different groups.

16. An electronic appliance comprising:
a plurality of LEDs; and
the power supply circuit of claim 1 for driving the LEDs.
